(19) United States
(12) Patent Application Publication
(10) Pub. No.: US 2022/0414539 A1
(43) Pub. Date: Dec. 29, 2022

(54) MACHINE LEARNING PERFORMANCE MONITORING AND ANALYTICS

(71) Applicant: Mona Labs Inc., Atlanta, GA (US)

(72) Inventors: Yotam OREN, Atlanta, GA (US); Nimrod TAMIR, Tel Mond (IL); Itai BAR SINAI, Tel Aviv (IL)

(73) Assignee: Mona Labs Inc., Atlanta, GA (US)

(21) Appl. No.: 17/780,989

(22) PCT Filed: Nov. 26, 2020
(86) PCT No.: PCT/IB2020/061192

§ 371 Date: May 29, 2022

Related U.S. Application Data
(60) Provisional application No. 62/941,839, filed on Nov. 28, 2019.

(51) Int. Cl. G06N 20/00; G06F 11/34; G06F 17/18

(52) U.S. Cl. CPC G06N 20/00; G06F 11/3447; G06F 17/18; G06F 2201/81

(57) ABSTRACT

A system comprising at least one hardware processor; and a non-transitory computer-readable storage medium having stored thereon program instructions, the program instructions executable by the at least one hardware processor to: receive a test dataset comprising data associated with test dataset of a machine learning model applied to target data, generate a set of expected values associated with the test dataset, and analyze the test dataset, based, at least in part, on the set of expected values, to detect a variance between the test dataset and the set of expected values, wherein the variance is indicative of an accuracy parameter of the machine learning model.

### CROSS REFERENCE TO RELATED APPLICATIONS

This application claims the benefit of priority of U.S. Provisional Patent Application No. 62/941,839, filed on Nov. 28, 2019, the contents of which are incorporated by reference as if fully set forth herein in their entirety.

### BACKGROUND

The invention relates to the field of machine learning.

Machine learning (ML) is concerned with the design and the development of algorithms that take as input data (such as statistics, metrics, and indicators), and recognize complex patterns in these data. These patterns are then used to classify and/or make determinations with respect to new, target, data. ML is a very broad discipline used to tackle very different problems, such as linear and non-linear regression, classification, clustering, dimensionality reduction, anomaly detection, optimization, and association rule learning.

Many applications of machine learning (ML) may suffer from drift and/or decay issues over time. Concept drift occurs when target data to which the trained ML algorithm is being applied change, so that the original training data is no longer representative of the space to which the ML algorithm is applied, and decision boundaries shift.

Machine learning models may also suffer from data bias. This issue occurs when the original training data does not accurately represent the real world. Consequently, the ML model then has a bias. For example, a facial recognition system that is trained only on individuals of a specified skin tone may not be effective in recognizing faces of individuals having different skin tones.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, a system comprising at least one hardware processor; and a non-transitory computer-readable storage medium having stored thereon program instructions, the program instructions executable by the at least one hardware processor to: receive a test dataset comprising data associated with a runtime application of a machine learning model to target data, generate a set of expected values associated with the test dataset, and analyze the test dataset, based, at least in part, on the set of expected values, to detect a variance between the test dataset and the set of expected values, wherein the variance is indicative of an accuracy parameter of the machine learning model.

There is also provided, in an embodiment, a method comprising: receiving a test dataset comprising data associated with test dataset of a machine learning model applied to target data; generating a set of expected values associated with the test dataset; analyzing the test dataset, based, at least in part, on the set of expected values, to detect a variance between the test dataset and the set of expected values, wherein the variance is indicative of an accuracy parameter of the machine learning model.

There is further provided, in an embodiment, a computer program product comprising a non-transitory computer-readable storage medium having program instructions embodied therewith, the program instructions executable by at least one hardware processor to: receive a test dataset comprising data associated with test dataset of a machine learning model applied to target data; generate a set of expected values associated with the test dataset; and analyze the test dataset, based, at least in part, on the set of expected values, to detect a variance between the test dataset and the set of expected values, wherein the variance is indicative of an accuracy parameter of the machine learning model.

In some embodiments, the generating of the test dataset comprises selecting data from the test dataset based, at least in part, on some of: specified data fields; specified data field types; specified data field value ranges; specified values associated with a statistical or mathematical operation applied to the data fields; specified test dataset size; and specified time period associated with the test dataset.

In some embodiments, the set of expected values comprises at least some of: (i) actual ground truth results corresponding to the test dataset; (ii) values associated with historical test dataset of the machine learning model; (iii) values associated with data selected from the current test dataset, wherein the selected data is different than the test dataset; and (iv) values associated with training data used to train the machine learning model.

In some embodiments, the variance is determined based, at least in part, on one or more of a missing value in the test dataset compared to the set of expected values; a value in the test dataset that is out of a range calculated from the set of expected values; a value in the test dataset that violates a threshold calculated from the set of expected values; and a statistic that violates a threshold calculated from the set of expected values.

In some embodiments, at least some of the range, threshold, and statistic are calculated by applying a trained machine learning model to the set of expected values.

In some embodiments, the machine learning model is one of a statistical regression model, a supervised machine leaning model, an unsupervised machine leaning model, and a deep leaning machine leaning model.

In some embodiments, the test dataset comprises at least some of: data associated with an input of the machine learning model, pre-processing results of the input of the machine learning model, intermediate prediction results of the machine learning model, final prediction results of the machine learning model, and confidence scores associated with prediction results of the machine learning model.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 illustrates an exemplary system for automated monitoring and assessment of the performance of machine learning models, according to an embodiment;

FIG. 2 is a flowchart detailing the functional steps in a process for automated monitoring and assessment of the performance of machine learning models, according to an embodiment;

FIGS. 3A-3C illustrate exemplary graphical and/or visual representations of analysis results, according to an embodiment; and

FIG. 4 illustrates an exemplary visualization of a feature vector comparison between a test and benchmark datasets, according to an embodiment.

### DETAILED DESCRIPTION

Disclosed herein are a method, system, and computer program product for automated monitoring and assessment of the performance of machine learning models, including deep learning algorithms, statistical models, and artificial intelligence models. In some embodiments, the present disclosure provides for a qualitative assessment of model predictions, decisions, and/or predictions of a machine learning model under observation.

In some embodiments, the present disclosure is directed to the management and/or evaluation of machine-learned models based on an analysis or runtime model predictions. In particular, the systems and methods of the present disclosure can obtain a machine-learned model and can evaluate at least one performance metric for the machine-learned model. In another example, the present disclosure provides for obtaining a plurality of machine-learned models and evaluating at least one performance metric for each of the plurality of machine-learned models.

In some embodiments, a system of the present disclosure acquires data from runtime predictions of a monitored machine learning model during one or more periods of runtime, to generate a test dataset. In some embodiments, the test dataset is representative of the output of the monitored machine learning model during these periods of runtime. In some embodiments, the test dataset is acquired based, at least in part, on user-selected and/or predefined data selection parameters. In some embodiments, the test dataset may further comprise actual ground-truth data corresponding to the model's output.

In some embodiments, the test dataset is parsed, segmented, sorted, and/or otherwise processed based, e.g., on specified metrics and/or rules.

In some embodiments, one or more predefined analytical model may then be applied to the test dataset, to identify, e.g., variances between the runtime output and the expected values of the machine learning model as initially configured.

In some embodiments, a system of the present disclosure may then be configured to provide assessment and monitoring indications and/or alerts to a user of the system, e.g., through tailored visualizations and/or similar means.

As used herein, the term ‘machine learning’ refers to an area of computer science which uses cognitive learning methods to program a computer system without using explicit instructions.

A ‘machine learning model’ or ‘prediction model’ may refer to any trained model which may be applied to runtime data to produce a predictive result. For example, a model may include a predictive ensemble, a learned function, a set of learned functions, or the like. A predictive result, in various embodiments, may include a classification or categorization, a ranking, a confidence metric, a score, an answer, a forecast, a recognized pattern, a rule, a recommendation, or any other type of prediction. For example, a predictive result for credit analysis may classify one customer as a good or bad credit risk, score the credit risk for a set of loans, rank possible transactions by predicted credit risk, provide a rule for future transactions, or the like. A machine learning model may be based on any rule, function, algorithm, set of rules, functions, and/or algorithms to make predictions on future data. For example—a linear regression algorithm, or Random Forest decision tree.

The terms ‘model run,’ ‘model activation,’ or ‘runtime’ broadly refer to the process of applying a trained machine learning model to target inputs, to obtain predictions. A model run can also refer to an iteration of an automated process which builds a machine learning model continuously with newly available data.

The term ‘model fidelity’ refers to the reliability and dependability of a machine learning model with respect to making predictions on given inputs over time.

The term ‘data integrity’ refers to the consistency and adherence of any input coming into a machine learning model to its expected format.

Accordingly, in various embodiments, machine learning may be used to generate a predictive model based on training data. The trained model may then be applied to runtime data to generate runtime predictions. In various embodiment, runtime data may refer to any data upon which a prediction or a predictive result may be based. For example, runtime data may include medical records for healthcare predictive analytics, credit records for credit scoring predictive analytics, records of past occurrences of an event for predicting future occurrences of the event, or the like. In certain embodiments, runtime data may include one or more records. In various embodiments, a record may refer to a discrete unit of one or more data values. For example, a record may be a row of a table in a database, a data structure including one or more data fields, or the like. In certain embodiments, a record may correspond to a person, organization, or event. For example, for healthcare predictive analytics, a record may be a patient's medical history, a set or one or more test predictions, or the like. Similarly, for marketing predictions, a record may be a set of data about a marketing campaign. Various types of records for predictive analytics will be clear in view of this disclosure.

In certain embodiments, records within training data may be similar to records within runtime data. However, training data may include data that is not included in the runtime data. For example, training data for marketing predictions may include results of previous campaigns (in terms of new customers, new revenue, or the like), that may be used to predict results for prospective new campaigns. Thus, in certain embodiments, training data may refer to historical data for which one or more results are known, and runtime data may refer to present or prospective data for which one or more results are to be predicted.

In certain embodiments, a model applied to produce predictive results may include one or more learned functions based on training data. In general, a learned function may include a function that accepts an input (such as training data or runtime data) and provides a result.

In some embodiments, a trained machine learning model may undergo drift over time, e.g., a detectable change, or to a change that violates a threshold, in one or more inputs and/or output for a model.

In some embodiments, model drift may take one of the following forms:

A change in the distribution of inputs, e.g., new values or a new make-up of existing values; or A change in the interpretation of the old inputs, which results in a decline in the predictive ability of the model even if the there's no real change in the runtime inputs.

For example, a model may be trained to identify textual content in French text, based on a training set comprising samples originating from France. However, during runtime, the model may be applied to content originating from another French-speaking region (e.g., Quebec, Canada), and thus contain terms that were not included in the training data. In another example, a model may be trained to predict university-level achievement based on samples high school student grade records dating from a specific era (e.g., the 1980's). In runtime, the model may be asked to perform predictions with respect to student records from another era (e.g., the 2000's), in which grading conventions may be different.

In various embodiments, drift relating to one or more predictive results may affect one or more records. In one embodiment, drift may pertain to a single record of runtime data, or affect a single result. In some embodiments, drift may pertain to a larger segment of data records, e.g., at least 1% of the data records.

For example, if the training data establishes or suggests an expected range for a data value, an out-of-range value in a runtime data record may represent drift. In some embodiments, drift may affect multiple records, or pertain to multiple results. For example, if the training data establishes or suggests an expected average for a data value in the runtime data or in the predictive results, then a shift for the average value over time may represent drift, even if individual records or results corresponding to the shifted average are not out of range.

In some embodiments, drift and/or another change in an input or output may comprise one or more values not previously detected for the input or output, not previously detected with a current frequency, or the like. For example, in various embodiments, drift may represent a value for a monitored input and/or output that is outside of a predefined range (e.g., a range defined based on training data for the input and/or output), missing, different than an expected value, meets a threshold difference from an expected and/or previous value, or has a ratio that varies from an expected and/or previous ratio.

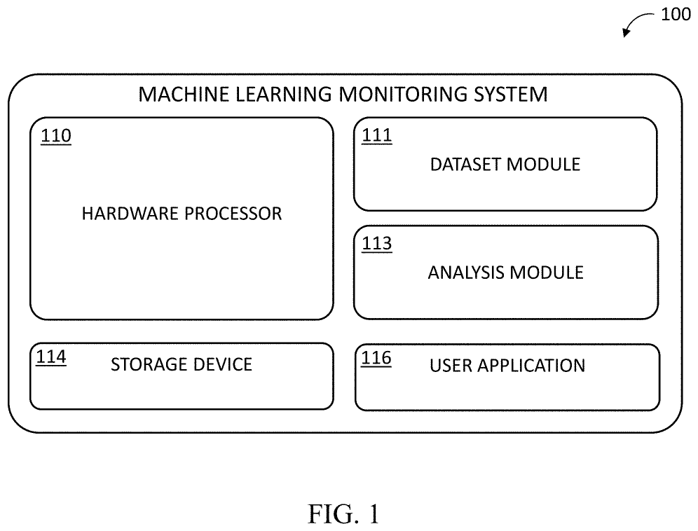

FIG. 1 illustrates an exemplary system 100 for automated monitoring and assessment of the performance of machine learning models, in accordance with some embodiments of the present invention. System 100 as described herein is only an exemplary embodiment of the present invention, and in practice may have more or fewer components than shown, may combine two or more of the components, or a may have a different configuration or arrangement of the components. The various components of system 100 may be implemented in hardware, software, or a combination of both hardware and software. In various embodiments, system 100 may comprise a dedicated hardware device, or may form an addition to or extension of an existing medical device.

In some embodiments, system 100 may comprise a hardware processor 110 and memory storage device 114. In some embodiments, system 100 may store in a non-volatile memory thereof, such as storage device 114, software instructions or components configured to operate a processing unit (also “hardware processor,” “CPU,” or simply “processor”), such as hardware processor 110. In some embodiments, the software components may include an operating system, including various software components and/or drivers for controlling and managing general system tasks (e.g., memory management, storage device control, power management, etc.) and facilitating communication between various hardware and software components.

In some embodiments, non-transient computer-readable storage device 114 (which may include one or more computer readable storage mediums) is used for storing, retrieving, comparing, and/or annotating acquired data. The software instructions and/or components operating hardware processor 110 may include instructions for receiving and analyzing acquired data. For example, hardware processor 110 may comprise a dataset module 111 and an analysis module 113. In some embodiments, dataset module 111 is configured to receive data associated with a machine learning model under observation and generate a test dataset that is representative of the output of the monitored machine learning model. In some embodiments, the received data may comprise training data, test data, runtime data, ground truth data, or the like. In some embodiments, analysis module 113 may be applied to the test dataset constructed by dataset module 111, and perform analyses thereon to monitor and asses the performance of the monitored machine learning model.

In some embodiments, system 100 may further comprise a user application 116 configured, e.g., to enable a user of the system to generate and view predefined and/or customized reports, analysis results, and/or other presentations.

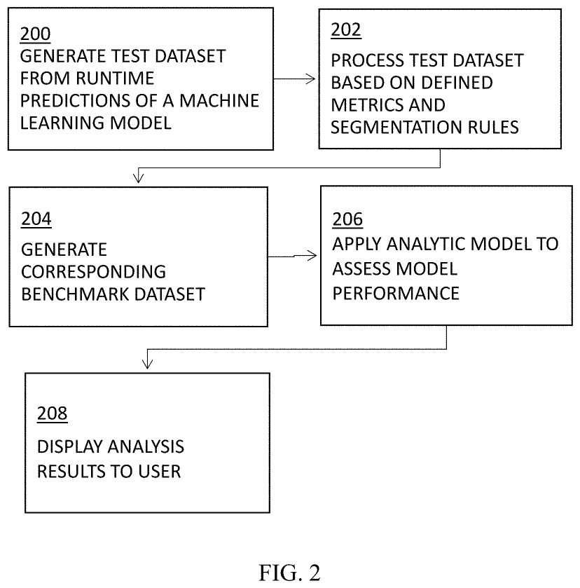

FIG. 2 is a flowchart detailing the functional steps in a process for automated monitoring and assessment of the performance of machine learning models, in accordance with some embodiments of the present invention.

At step 200, in some embodiments, system 100 may be configured to acquire a test dataset representative of a runtime application of one or more machine learning models of interest under monitoring and/or observation. In some embodiments, the acquired data are raw outputs of the monitored machine learning model in production.

In some embodiments, the test dataset may be labeled and/or tagged with identifiers representing specific runs of the monitored models. In some embodiments, such identifiers may comprise, e.g., timestamps, specific model runs, specific model versions, etc. In some embodiments, data labelling is based, e.g., on user configuration and/or input. In some embodiments, dataset labels and/or tags enable processing, modifying, adding, and/or parsing of the test dataset, based, e.g., on user-defined parameters and selections.

In some embodiments, these identifiers enable a user of the system to add data at different points in time and automatically correlate them with specific model runs. For example, actual real-world ‘ground truth’ results associated with predictions made by a model in runtime may become available only after runtime has completed. In such cases, ground truth data may be spliced into the test dataset at specified locations using, e.g., the identifiers which enable the system to associate the added data with existing predictions of a runtime.

In some embodiments, at step 202, the present disclosure provides for processing of the test dataset consistent with a specified set of metrics. In some embodiments, such metrics may be user-defined and/or user-configured. In some embodiments, such metrics may comprise:

The values and/or data fields to include in the test dataset (e.g., prediction value, confidence score associated with prediction value, etc.);

mathematical and/or statistical operations to perform on the values and/or data fields (e.g., variance of confidence score);

descriptions of data type (e.g., scalar or vector), expected and/or permitted value ranges, special values, etc. (e.g., the distribution of values in a feature vector).

In some embodiments, step 202 may comprise processing the test dataset, to calculate and store values associated with the monitored metrics.

For example, a user-configured monitored metric may comprise monitoring a variance and/or another difference and/or relationship between the values of two specified data fields. Accordingly, values for this monitored metric may be calculated and stored for further analysis.

In a non-limiting example, a test dataset obtained from the output of a machine learning model may comprise all confidence scores associated with predictions generated by the model during a specified period of time (e.g., one day). A monitored metric of interest for this test dataset may in turn be defined as a statistic (e.g., average, median, etc.) calculated with respect to the confidence score dataset.

In some embodiments, the test dataset may be further processed and prepared for analysis by performing, e.g., further indexing, labeling, and/or similar other operations with respect thereto. In some embodiments, the additional data preparation may be consistent with a set of segmentation rules, which later enable designating specified portions of the test dataset for analysis, e.g., through filtering, sorting, and/or similar operations. In some embodiments, segmentation rules comprise data fields or combinations thereof used for sorting and filtering the test dataset. For example, a segmentation rule may be to filter all model runs of a specified model version.

In some embodiments, such segmentation rules may comprise:
Declaration of data field(s) that will be used for sorting and/or filtering;
designation of mathematical or statistical operations to perform on the data fields;
description of type, including expected and/or permitted values and ranges;
segmentation hierarchy;
segmentation scaling (e.g., logarithmic-based, linear, polynomial or exponential);
automatic detection for target number of segments;
automatic detection by segments size targets;
segmentation by statistical properties (e.g., averages, percentiles, variance);
differential dynamic segmentation (e.g., wherein segments may be further can split, based on configuration and monitored data);
for vector data fields, clustering by smart algorithms, including:
   machine-learning based (unsupervised with given target properties),
   hierarchical clustering algorithms (parameterized),
   k-clustering algorithms (parameterized); and
hard-coded segments.

In some embodiments, at the conclusion of processing step 202, the present disclosure may provide for a test dataset that is configured to enable further analysis of the test dataset.

In some embodiments, at step 204, the present disclosure provides for generating a benchmark dataset comprising, at least in part, an expected set of values of the machine learning model under observation, as initially configured.

In some embodiments, the benchmark dataset may comprise runtime data not selected for the test dataset.

In some embodiments, the expected values of the machine learning model may comprise a plurality of monitored metrics of the machine learning model. In some embodiments, the monitored metrics may comprise model inputs, calculated intermediate scores and/or other outputs of the model, and/or final outputs of the model.

In some embodiments, the benchmark dataset enables detection of variances between the runtime predictions and the expected values of the machine learning model. In some embodiments the benchmark dataset comprises, at least in part, ground truth results corresponding to the runtime predictions in the test dataset.

In some embodiments, the benchmark dataset may be configurable by a user of the system. In some embodiments, a benchmark dataset may be defined, e.g., in one of the following ways:
Time Segmentation: Monitored values from runtime predictions of the machine learning model within a specified timeframe, e.g., last 60 days, an incubation period of the model, and/or a validation period of the model. In such cases, the test and benchmark datasets will be acquired during the same specified time period, but may comprise different data segments. In some embodiments, the test and benchmark datasets may comprise data obtained before and after a timestamp during a specified period (e.g., every N predictions, once a day, once a week, once a month, and/or another period).
Data Segmentation: Monitored values from runtime predictions of the machine learning model acquired in a specified segment and/or portion of the predictions data. In such cases, the test and benchmark datasets will comprise similar data segments acquired during different time periods.

In the non-limiting example stated above, a test dataset may comprise of confidence scores associated with predictions generated by a machine learning model in a specified time period, and a relevant monitored metric may be a statistic (e.g., average) associated with the test dataset. In such an example, a benchmark dataset may be, e.g., historical average confidence scores.

In some embodiments, differences and variances may be defined based, at least in part, on the parameters of the benchmark dataset. For example, for benchmark datasets defined with reference to a specified timeframe, the present disclosure may provide for detecting significant variances between a test segment and all other data segments acquired during that time period.

In some embodiments, the benchmark dataset may comprise historical values of the monitored metric. For example, in a case where a monitored metric is a zip code associated with a data record, a monitored metric value may be the variance in the proportion of data records associated with the specified zip code in the runtime data as compared to the training data. When such a variance exceeds a threshold, for example, the machine learning model may be experiencing drift.

In cases where the benchmark dataset is defined based on data segmentation, the present disclosure may seek to determine whether the examined segment has experienced a meaningful sudden or gradual change (often dubbed “concept drift”) in any one of specified metrics relative to the benchmark dataset.

In some embodiments, at step 206, the present disclosure provides for one or more trained analytical models, to apply to the test dataset for automated analysis and assessment of a machine learning model under observation.

In some embodiments, a comparison between a test and benchmark datasets may employ one or more various algorithms, including, but not limited to:
Dynamic Rule-based Comparisons: Determination of meaningful change by comparing monitored values to dynamic thresholds. The threshold are computed via statistical measurements (e.g., average, variance, percentiles, other distribution properties) and configurable sensitivity levels. For example, a threshold could be “twice the distance between the median and the 99th percentile of the benchmark set.”
Machine Learning Models: Determination of meaningful change by comparing monitored values to predicted/expected values. The predicted values are produced by mathematical models trained by any of the following algorithms:
   Statistical Regression: One or more statistical regression algorithms, such as linear regression, polynomial, Ridge, Lasso, partial least squares (PLS), logistic, and quantile regressions. In some embodiments, a statistical regression model may be selected based, at least in part on system configuration and/or data types. In some embodiments, such detection methods as CUSUM (Cumulative Sum), GMA (Geometric Moving Average), hypothesis testing methods, Kolmogorov-Smirnov test, DDM (Drift Detection Method), EWMA (Exponential Moving Average) may be used.
   Unsupervised Machine Learning: Clustering of monitored values in different time periods within the benchmark and target periods, including K-Means algorithms, Hierarchical clustering, Density-Based Spatial Clustering of Applications with Noise (DBSCAN), and Gaussian mixture model (GMM) algorithms.
   Supervised Machine Learning: When ground truth data corresponding to runtime predictions is available within the test dataset, it may be used to train models (e.g., random forest, gradient boosting trees, perceptron) to learn, based on the benchmark data, how changes in behavioral metrics in various segments impacts changes in the overall quality of the model. In some embodiments, the overall quality may be defined via a comparison between ground truth data and model runtime predictions. vs. predictions. Using this model on the target period, the system fine tunes the ability to distinguish the degree of significant differences.
   Deep Learning: When sufficient data is available, analysis may use, e.g., an RNN with a tailored architecture and configuration to accommodate the underlying problem.

In some embodiments, difference and/or variance and/or other changes detected in the test dataset may comprise one or more values not previously detected in the test dataset, not previously detected with a current frequency, or the like. For example, in various embodiments, analysis module 113 may determine whether a value for a monitored input and/or output is outside of a predefined range (e.g., a range defined based on training data for the input and/or output), whether a value is missing, whether a value is different than an expected value, whether a value satisfies at least a threshold difference from an expected and/or previous value (e.g., analysis module 113 may set a threshold for detecting drift higher than 3% baseline variation, 4%, 5%, 10%, or the like), whether a ratio of values (e.g., male and female, yes and no, true and false, zip codes, area codes) varies from an expected and/or previous ratio, or the like.

In certain embodiments, baseline variation may occur relating to predictive results. For example, input drift, or runtime data drift, may occur when the runtime data drifts from the training data. A data value, set of data values, average value, or other statistic in the runtime data may be missing, or may be out of a range established by the training data, due to changing data gathering practices and/or a changing population that the runtime data is gathered from. As another example, output drift may occur where a predictive result, a set of predictive results, statistic for a set of predictive results, or the like, is no longer consistent with actual ground truth outcomes, outcomes in the training data, prior predictive results, or the like.

In some embodiments, analysis module 113 may perform a statistical analysis of one or more values in the test and benchmark datasets, to compare, e.g., a statistical distribution of predictions, an anomaly in the results, a ratio change in classifications, a shift in values of the results, or the like.

In certain embodiments, analysis module 113 may break up and/or group predictions in the test dataset into classes or sets, e.g., by row, by value, by time, or the like, and may perform a statistical analyses of the classes or sets. For example, analysis module 113 may determine that a size and/or ratio of one or more classes or sets has changed and/or drifted over time, or the like. In one embodiment, analysis module 113 may monitor and/or analyze confidence metrics in the test and benchmark datasets, to detect, e.g., if a distribution of confidence metrics becomes bimodal and/or exhibits a different change.

In various embodiments, analysis module 113 may apply a model (e.g., a predictive ensemble, one or more learned functions, or the like) to test datasets, to produce predictive results. Learned functions of the model may be based on training data.

In some embodiments, at step 208, results of the analysis in step 206 may be provided to a user of system 100 using, e.g., user application 116. In some embodiments, application 116 may comprise a computer program and/or application configured to collect analysis results and generate a plurality of graphical, statistical, and/or other reports and/or presentations to a user of the system,

In some embodiments, user application 116 may comprise a facility for a user to generate and/or manipulate system reports and data views, as well as, e.g., an investigation tool enabling comprehensive exploration of monitored values of behavioral metrics in every monitored segment, model multidimensional benchmarking, reports, alerts (current and historical), and configuration management.

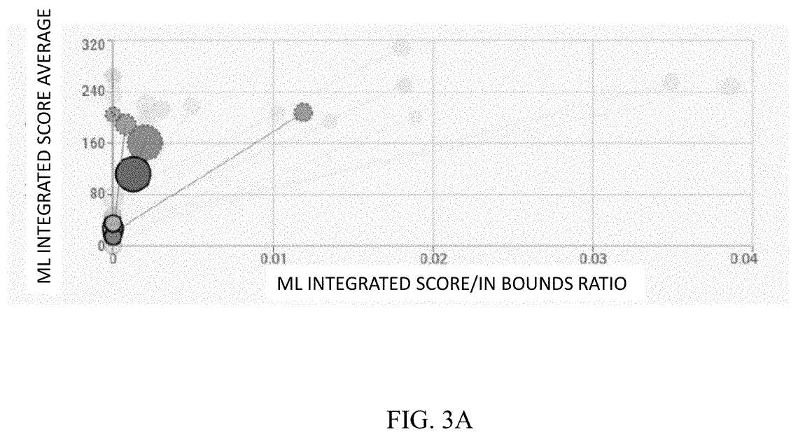

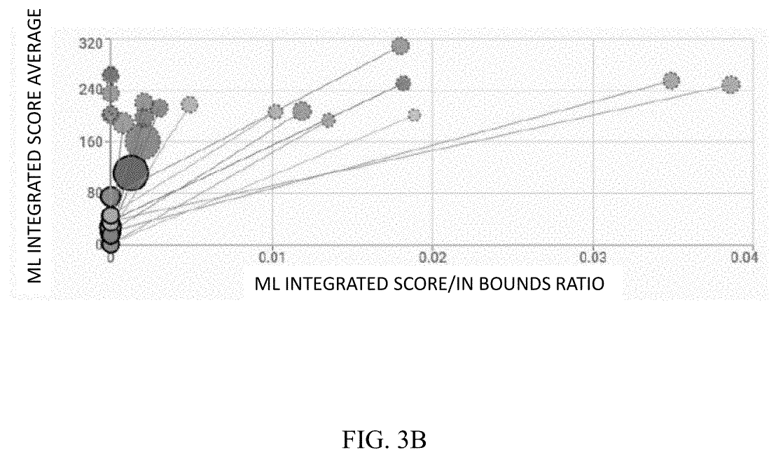

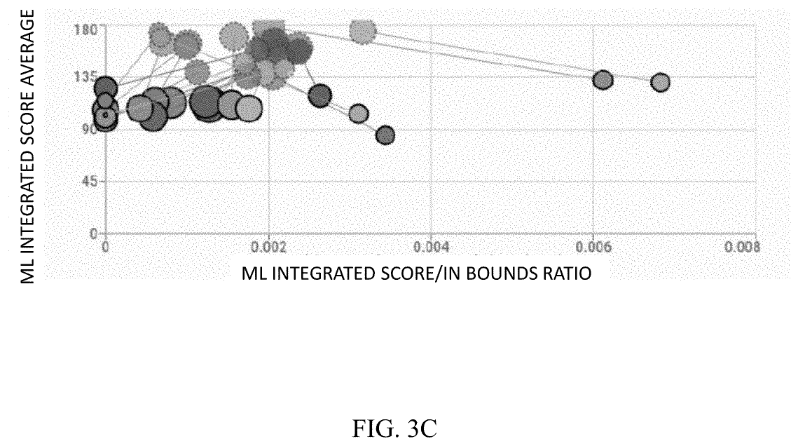

For example, user application 116 may provide a graphical and/or visual representation of analysis results, as illustrated in FIGS. 3A-3C. In some embodiments, such representation may be in the form of a bubble chart visualization, wherein each bubble color represents a data segment, each data segment correlates with two bubbles representing the test and benchmark datasets connected by a line, and wherein a corresponding score card with the normalized axis values is shown upon hover over a bubble area.

In some embodiments, a user of the system may parse the presented data based on, e.g., data segments, wherein the user may control dimensions by presented segments may be defined, the number of segments to show (e.g., top 20), metrics and values to use in order to prioritize which segments to show (e.g., top, bottom, increased/decreased the most from benchmark period to target period). A user may further configure presentation axes, based on, e.g., desired statistical computations (e.g., average, percentile, variance, standard deviation). A user may further manipulate a Z axis presentation (e.g., bubble size) as base don absolute or relative values. In some embodiments, a control feature of user application 116 may present data to a user using, e.g., a tabular view of the values of all segments, periods and axis, etc. A user may then select, e.g., elect segments for highlighting, segments to hide (e.g., to remove outliers from consideration).

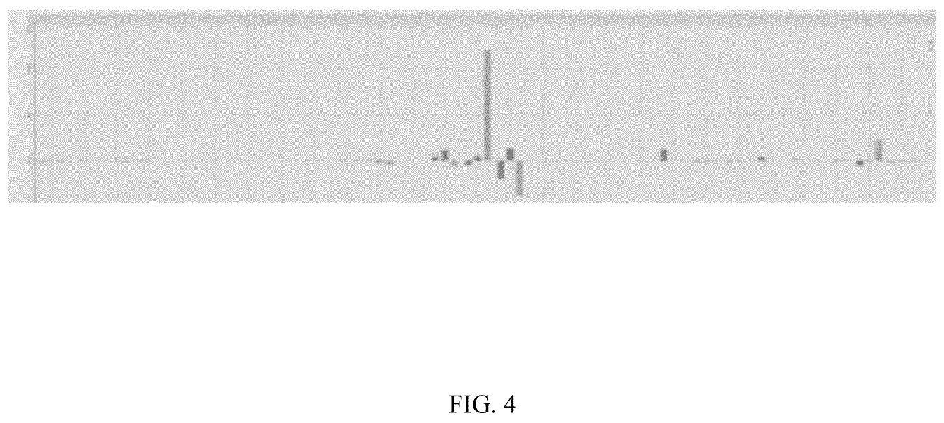

In some embodiments, as can be seen in FIG. 4, user application 116 may visualize a feature vector comparison between a test and benchmark datasets

In some embodiments, in response to detecting baseline variance or other change, user application 116 may notify a user or other client. For example, user application 116 may set a variance flag or other indicator in a response (e.g., with or without a prediction or other result); send a user a text, email, push notification, pop-up dialogue, and/or another message (e.g., within a graphical user interface of system 100); and/or may otherwise notify a user.

User application 116 may provide a flag or other indicator at a record granularity (e.g., indicating which record(s) include one or more drifted values), at a feature granularity (e.g., indicating which feature(s) include one or more drifted values), or the like. In certain embodiments, user application 116 provides a flag or other indicator indicating an importance and/or priority of the drifted record and/or feature (e.g., a ranking of the drifted record and/or feature relative to other records and/or features in order of importance or impact on a prediction or other result, an estimated or otherwise determined impact of the drifted record and/or feature on a prediction or other result, or the like).

In some embodiments, user application 116 provides a user with a summary comprising one or more statistics, such as a difference in one or more values over time, a score or other indicator of a severity of the variance or change, a ranking of the variance record and/or feature relative to other records and/or features in order of importance or impact on a prediction or other result, an estimated or otherwise determined impact of the variance record and/or feature on a prediction or other result, or the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a hardware processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that user application 116 controls.

1. A system comprising:
at least one hardware processor; and
a non-transitory computer-readable storage medium having stored thereon program instructions, the program instructions executable by the at least one hardware processor to:
receive a test dataset comprising data associated with a runtime application of a machine learning model to target data,
generate a set of expected values associated with said test dataset, and
analyze said test dataset, based, at least in part, on said set of expected values, to detect a variance between said test dataset and said set of expected values, wherein said variance is indicative of an accuracy parameter of said machine learning model.

2. The system of claim 1, wherein said generating of said test dataset comprises selecting data from said test dataset based, at least in part, on some of: specified data fields;
specified data field types; specified data field value ranges; specified values associated with a statistical or mathematical operation applied to said data fields; specified test dataset size; and
specified time period associated with said test dataset.

3. The system of claim 1, wherein said set of expected values comprises at least some of:
(i) actual ground truth results corresponding to said test dataset;
(ii) values associated with historical test dataset of said machine learning model;
(iii) values associated with data selected from said current test dataset, wherein said selected data is different than said test dataset; and
(iv) values associated with training data used to train said machine learning model.

4. The system of claim 1, wherein said variance is determined based, at least in part, on one or more of a missing value in the said test dataset compared to said set of expected values; a value in the test dataset that is out of a range calculated from said set of expected values; a value in the test dataset that violates a threshold calculated from said set of expected values; and a statistic that violates a threshold calculated from said set of expected values.

5. The system of claim 4, wherein at least some of said range, threshold, and statistic are calculated by applying a trained machine learning model to said set of expected values.

6. The system of claim 5, wherein said machine learning model is one of a statistical regression model, a supervised machine leaning model, an unsupervised machine leaning model, and a deep leaning machine leaning model.

7. The system of claim 1, wherein said test dataset comprises at least some of: data associated with an input of said machine learning model, pre-processing results of said input of said machine learning model, intermediate prediction results of said machine learning model, final prediction results of said machine learning model, and confidence scores associated with prediction results of said machine learning model.

8. A method comprising:
receiving a test dataset comprising data associated with a runtime application of a machine learning model to target data;
generating a set of expected values associated with said test dataset;
analyzing said test dataset, based, at least in part, on said set of expected values, to detect a variance between said test dataset and said set of expected values, wherein said variance is indicative of an accuracy parameter of said machine learning model.

9. The method of claim 8, wherein said generating of said test dataset comprises selecting data from said test dataset based, at least in part, on some of: specified data fields;
specified data field types; specified data field value ranges; specified values associated with a statistical or mathematical operation applied to said data fields; specified test dataset size; and
specified time period associated with said test dataset.

10. The method of claim 8, wherein said set of expected values comprises at least some of:
(i) actual ground truth results corresponding to said test dataset;
(ii) values associated with historical test dataset of said machine learning model;
(iii) values associated with data selected from said current test dataset, wherein said selected data is different than said test dataset; and
(iv) values associated with training data used to train said machine learning model.

11. The method of claim 8, wherein said variance is determined based, at least in part, on one or more of a missing value in the said test dataset compared to said set of expected values; a value in the test dataset that is out of a range calculated from said set of expected values; a value in the test dataset that violates a threshold calculated from said set of expected values; and a statistic that violates a threshold calculated from said set of expected values.

12. The method of claim 11, wherein at least some of said range, threshold, and statistic are calculated by applying a trained machine learning model to said set of expected values.

13. The method of claim 12, wherein said machine learning model is one of a statistical regression model, a supervised machine leaning model, an unsupervised machine leaning model, and a deep leaning machine leaning model.

14. The method of claim 8, wherein said test dataset comprises at least some of: data associated with an input of said machine learning model, pre-processing results of said input of said machine learning model, intermediate prediction results of said machine learning model, final prediction results of said machine learning model, and confidence scores associated with prediction results of said machine learning model.

15. A computer program product comprising a non-transitory computer-readable storage medium having program instructions embodied therewith, the program instructions executable by at least one hardware processor to:
receive a test dataset comprising data associated with runtime application of a machine learning model to target data;
generate a set of expected values associated with said test dataset; and
analyze said test dataset, based, at least in part, on said set of expected values, to detect a variance between said test dataset and said set of expected values, wherein said variance is indicative of an accuracy parameter of said machine learning model.

16. The computer program product of claim 15, wherein said generating of said test dataset comprises selecting data from said test dataset based, at least in part, on some of: specified data fields; specified data field types; specified data field value ranges; specified values associated with a statistical or mathematical operation applied to said data fields; specified test dataset size; and specified time period associated with said test dataset.

17. The computer program product of claim 15, wherein said set of expected values comprises at least some of:
(i) actual ground truth results corresponding to said test dataset;
(ii) values associated with historical test dataset of said machine learning model;
(iii) values associated with data selected from said current test dataset, wherein said selected data is different than said test dataset; and
(iv) values associated with training data used to train said machine learning model.

18. The computer program product of claim 15, wherein said variance is determined based, at least in part, on one or more of a missing value in the said test dataset compared to said set of expected values; a value in the test dataset that is out of a range calculated from said set of expected values; a value in the test dataset that violates a threshold calculated from said set of expected values; and a statistic that violates a threshold calculated from said set of expected values.

19. The computer program product of claim 18, wherein at least some of said range, threshold, and statistic are calculated by applying a trained machine learning model to said set of expected values.

20. The computer program product of claim 19, wherein said machine learning model is one of a statistical regression model, a supervised machine leaning model, an unsupervised machine leaning model, and a deep leaning machine leaning model.

21. (canceled)
